(19) United States
(12) Patent Application Publication
(10) Pub. No.: US 2006/0109385 A1
(43) Pub. Date: May 25, 2006

(54) Digital broadcast receiving apparatus

(76) Inventors: Takeshi Wakako, Takatsuki (JP); Tadashi Ono, Osaka (JP); Kouichi Hotta, Kobe (JP)

Correspondence Address: WENDEROTH, LIND & PONACK L.L.P., 2033 K. STREET, NW, SUITE 800, WASHINGTON, DC, 20006, US

(21) Appl. No.: 11/284,937

(22) Filed: Nov. 23, 2005

(30) Foreign Application Priority Data
Nov. 25, 2004 (JP) 2004-339718

(51) Int. Cl. H04N 5/50

(52) U.S. Cl. 348/731

(57) ABSTRACT

Provided is a digital broadcast receiving apparatus 1 for receiving a digital stream Wb obtained by interframe interpolation, in which a channel selection section 2 and 3 designates one of a plurality of channels and instructs reproduction of contents VS and AS, the contents reproduction section 4, 6, 11, and 17 reproduces the designated contents VS an AS, and the contents output section 12, 11, 18, and 17 outputs, when receiving an instruction for reproducing second contests VS(C) of a second channel during reproduction of first contents VS(P) of a first channel, the reproduced first contents VS(P) until reproduction of the second contents VS(C) is enabled.

### BACKGROUND OF THE INVENTION

1. Field of the Invention

The present invention relates to a digital broadcast receiving apparatus for receiving digital broadcast using interframe interpolation, and a method for selecting a channel. More particularly, the present invention relates to a method for outputting video and audio when a view channel is changed during reception of digital broadcast.

2. Description of the Background Art

Digital broadcast for providing, as a digital stream, contents including video, audio, text, management information, and the like, has been put into practical use. For example, terrestrial digital broadcast has been started in addition to BS digital broadcast and CS digital broadcast. Further, broadcasting dedicated to a mobile terminal will start in the near future. The mobile broadcasting uses a limited band and enables the mobile terminal to receive digital TV broadcast. For the digital broadcast, an MPEG2-TS (Transport Stream) in which contents including video, audio, and data such as text and management information are multiplexed into one stream to be transmitted, is used as a transmission method.

Video data to be multiplexed is coded using a coding method for performing interframe interpolation based on motion compensated interframe prediction as typified by MPEG2, H.264 and the like. A motion compensated interframe prediction represents a compression method in which a subsequent screen (hereinafter, referred to as “a subsequent screen”) is predicted using only differential data based on data from which a current screen (hereinafter, referred to as “a current screen”) is generated and a predicted subsequent motion of an object so as to enable reproduction of an image which is almost the same as an original image for the subsequent screen when interframe prediction in the time axis direction is performed. That is, an image for the current screen is interpolated using the differential data based on the current screen and the predicted subsequent motion of the object so as to obtain an image for the subsequent screen. Thus, the image data is compressed and encoded.

In order to decode video data having been compressed in the motion compensated interframe prediction so as to reproduce an image, required is a head picture represented by data which is encoded using only data of a current frame and which is not related to preceding frames and subsequent frames. Therefore, the head picture so encoded is inserted into the encoded video data at regular intervals. An intra-picture (hereinafter, referred to as an I-picture) is typically used as the head picture.

In H. 264, however, the reproduction state cannot be fully reset by using a typical I-picture. In this case, an IDR (Instantaneous Decoding Refresh) picture must be used. In order to reduce required transmission resource as compared to an I-picture, the IDR picture has no association with a preceding frame. However, the IDR picture is required to be used for reproducing an image obtained by interframe interpolation, as with an I-picture. Here, the I-picture is described as the head picture, for example. Although any picture based on a signal of a video obtained by interframe interpolation in the aforementioned MPEG2 or H.264 can be used as the head picture, using such picture will cause the same condition as when the I-picture or the IDR picture is used.

The digital broadcast receiving apparatus receives an MPEG2-TS multiple stream and demultiplexes the MPEG2-TS multiple stream so as to decode video and audio which have been encoded and which are associated with a service selected by a user and output the decoded video and audio. However, when a user selects his or her desired view channel, video data of the desired channel cannot be outputted until an I-picture is received. Therefore, a blackout occurs during a certain period or a blank period occurs in which a message such as “please wait . . . ” is displayed. This blank period occurs also when a channel being viewed is changed to another channel. Here, channel selection also includes channel change if not otherwise specified.

In order to solve the problem, disclosed in Japanese Laid-Open Patent Publication No. 2002-51325 is a method for eliminating a blank period by outputting, as a dummy image, advertisement data, program data, or the like which have already been stored and are currently held in a second output buffer in a period from reception of an I-picture to storage of video data in a first output buffer, or in a certain period longer than the period described above. Thus, an image displayed according to a channel selected by a user is referred to as “a channel selection image”, while an image outputted as a dummy instead of the channel selection image during the blank period is referred to as “a dummy image”. Video data for the channel selection image and video data for the dummy image are referred to as “channel selection image data” and “dummy image data”, respectively.

Further, disclosed in Japanese translation of PCT international application No. 2003-512781 is a method for outputting a dummy image such as advertisement data which has already been stored and is currently held in a second output buffer in a period from reception of an I-picture to storage of video data in a first output buffer, and subjecting the dummy image to visual transition adjustment such as zoom and wipe until the video data stored in the first output buffer is outputted, so as to smoothly shift, without any blank occurring, from the dummy image to an image outputted according to a channel selected by a user.

However, in both of the aforementioned methods, when the user starts to select a channel, the dummy image data is required to have already been stored in the second output buffer. Further, in a case where the advertisement data and the like are obtained as dummy image data from data being broadcasted, a broadcast station is required to prepare contents used as the dummy image data, thereby increasing a load on the broadcast station. Moreover, the dummy image data can be obtained through a network instead of through data broadcasting. In this case, however, a user must set connection configuration, obtain dummy image data and the like, thereby increasing the user's burden.

In addition, it is not suggested that the dummy image data stored in the second output buffer is kept updated. That is, the same dummy image (advertisement data and the like) are displayed every time a channel is selected, which makes a user feel irritated. In the method as disclosed in Japanese Laid-Open Patent Publication No. 2002-51325, when the displayed dummy image is, especially, a still image and the displayed dummy image is the same every time a channel is selected, the user feels dissatisfied with the same image. Therefore, the user feels irritated with seeing the same dummy image until an image of a selected channel is displayed. Further, when the image of the selected channel starts to be displayed, the user may have directed attention to elsewhere other than the display. Consequently, the user may miss the image of the selected channel.

In addition, every time a user selects a channel, the user is shown the same dummy image which is not associated with the image of the selected channel, whereby the user is concerned about whether the display of the dummy image is an appropriate process for shifting to display of the image of the selected channel or a malfunction has occurred due to a human error such as a user operation error or a hardware failure such as a breakdown occurring in a receiving apparatus. When the dummy image is a still picture, the user feels increasingly concerned about this.

In the method as disclosed in Japanese translation of PCT international application No. 2003-512781, the dummy image is subjected to visual transition adjustment such as zoom and wipe so as to vary the dummy image, thereby preventing the dummy image from being always the same. In this case, however, the same dummy image data is always used and subjected to a predetermined process. That is, the same dummy image data varies only in a predetermined manner. Therefore, the user eventually feels dissatisfied with the dummy image varying in the predetermined manner. Accordingly, the aforementioned problem cannot be solved.

The aforementioned problem occurs principally because an image having no association with a screen having been displayed, is displayed in a blank period up to display of a channel selection image, which causes the user to feel that the display of images is interrupted. That is, while the dummy image is displayed during channel selection operation, the user feels that the dummy image has little association with the user's channel selection operation. Similarly, the dummy image has little association with the channel selection image. Further, the dummy image displayed during the channel selection operation has less association with the channel selection operation than the channel selection image. In other words, although the dummy image is displayed so as to smoothly shift to a channel selection image in a blank period from channel selection to display of a channel selection image, the user feels that the display of images is interrupted by displaying the dummy image when a channel is selected. As a result, the user soon feels dissatisfied with seeing the dummy image displayed in the blank period and the user feels irritated with the same dummy image being repeatedly displayed. Accordingly, the user feels concerned about whether the display of the dummy image indicates an appropriate operation or not.

### SUMMARY OF THE INVENTION

An object of the present invention is to provide a digital broadcast receiving apparatus which generates dummy image data based on data which is closely related to channel selection operation, and displays a dummy image based on the dummy image data in a blank period until video data are stored in a first output buffer after an I-picture is received, thereby enabling a smooth change to an image of a selected channel without irritating a user. A digital broadcast receiving apparatus for receiving a digital stream obtained by subjecting a plurality of contents provided on a plurality of channels to interframe interpolation, selecting one of the plurality of contents and reproducing the selected contents, the digital broadcast receiving apparatus comprising:

a reproduction channel designating unit to operable to designate one of the plurality of channels and instructing for reproduction of contents provided on the designated channel;

a contents reproducing unit to operable to reproduce contents of the channel designated by the reproduction channel designating unit; and

a contents output unit to operable to output the reproduced contents, wherein

when, during reproduction of first contents provided on a first channel, an instruction for reproducing second contents provided on a second channel is received from the reproduction channel designating unit, the reproduced first contents are outputted until reproduction and output of the second contents are enabled.

The digital broadcast receiving apparatus according to the present invention is operable to display a video corresponding to a service having been provided before channel changing, by adding thereto a message indicating that a channel is being selected, when receiving an instruction for changing a channel from a user, and display, as soon as received is an initial I-picture of a video corresponding to a service to be provided after the channel changing, the video corresponding to the service to be provided after the channel changing, thereby eliminating a blank period and smoothly changing the channel without irritating the user.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating a construction of a digital broadcast receiving apparatus according to an embodiment of the present invention;

FIG. 2 is a timing chart illustrating a channel change operation performed by the digital broadcast receiving apparatus shown in FIG. 1;

FIG. 3 is a flow chart explaining an operation performed by a video control instruction unit in the digital broadcast receiving apparatus shown in FIG. 1;

FIG. 4 is a diagram for explaining a video stream stored in a video buffer shown in FIG. 1 when a channel is changed;

FIG. 5 is a diagram for explaining a video stream stored in a video buffer shown in FIG. 1 when a channel is changed;

FIG. 6 is a diagram for explaining an example of a dummy image displayed during channel changing according to a first example of the present invention;

FIG. 7 is a diagram for explaining an example of a dummy image displayed during channel changing according to a second example of the present invention;

FIG. 8 is a diagram for explaining an example of a dummy image displayed during channel changing according to a third example of the present invention;

FIG. 9 is a diagram for explaining an example of a dummy image displayed during channel changing according to a fourth example of the present invention; and

FIG. 10 is a diagram for explaining an example of a dummy image displayed during channel changing according to a fifth example of the present invention.

### DESCRIPTION OF THE PREFERRED EMBODIMENTS

Hereinafter, a digital broadcast receiving apparatus according to an embodiment of the present invention will be described with reference to the drawings.

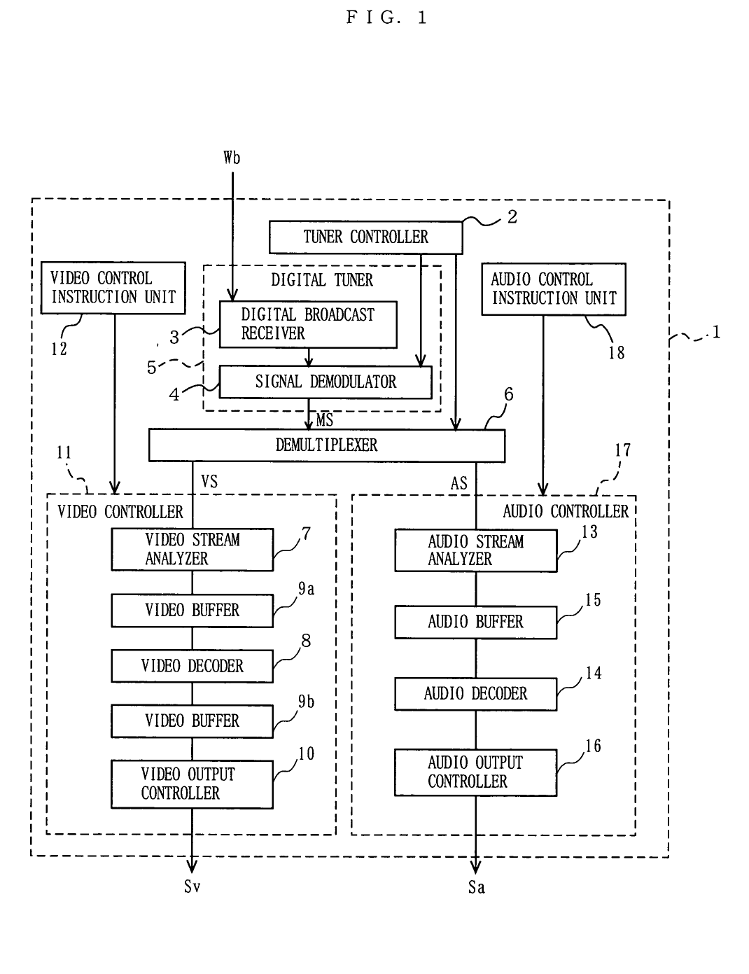

As shown in FIG. 1, a digital broadcast receiving apparatus 1 according to an embodiment of the present invention comprises: a tuner controller 2; a digital tuner 5; a demultiplexer 6; a video controller 11; a video control instruction unit 12; an audio controller 17; and an audio control instruction unit 18. The tuner controller 2 receives a channel selection operation performed by a user using a channel button, through cursor key input, or the like, and performs control so as to receive a service corresponding to the channel. In the present embodiment, the service represents contents which are received through the aforementioned digital broadcast or network and are provided as a digital stream. More particularly, the service represents programs which are broadcasted on different channels through digital broadcast using interframe interpolation.

The digital tuner 5 includes a digital broadcast receiver 3 and a signal demodulator 4. The digital broadcast receiver 3 receives a broadcast wave Wb. The signal demodulator 4 demodulates a digital signal from the received broadcast wave Wb to obtain an MPEG2-TS multiple stream MS. That is, the digital tuner 5 outputs to the demultiplexer 6 the MPEG2-TS multiple stream MS obtained from the received broadcast wave Wb.

The demultiplexer 6 demultiplexes the MPEG2-TS multiple stream MS outputted by the digital tuner 5 into a video stream VS and an audio stream AS. The video stream VS is outputted to the video controller 11 and the audio stream AS is outputted to the audio controller 17.

The video controller 11 generates a video signal Sv based on the video stream VS according to an instruction from the video control instruction unit 12. Specifically, the video controller 11 includes: a video stream analyzer 7; a video decoder 8; a first video buffer 9a; a second video buffer 9b; and a video output controller 10.

The video stream analyzer 7 analyzes the video stream VS outputted by the demultiplexer 6 to obtain a type of a picture. The first video buffer 9a temporarily stores the video stream VS outputted by the video stream analyzer 7, and outputs the stored video stream VS to the video decoder 8 according to an instruction from the video control instruction unit 12. The video decoder 8 decodes the video stream VS supplied from the first video buffer 9a to obtain video data representing an original video.

When the video stream VS supplied from the demultiplexer 6 after a user changes a channel is a P-picture, the video stream analyzer 7 abandons the video stream VS and the video decoder 8 is caused to decode video stream VS stored in the first video buffer 9a. On the other hand, when the video stream analyzer 7 receives an initial I-picture of the video stream VS after a user changes a channel, the first video buffer 9a is caused to erase video stream VS held therein and to store therein the received I-picture and video streams VS subsequent thereto.

The video decoder 8 decodes an image unit (hereinafter, referred to as “a reproduced image unit UI”) required for reproducing an image from the video stream VS stored in the video buffer 9a so as to generate video data and output the video data. The reproduced image unit UI is composed of an I-picture representing a still image and a plurality of I-pictures required for displaying a moving image, or composed of an I-picture representing a still image and non-I-pictures subsequent to the I-picture. The second video buffer 9b temporarily stores video data outputted by the video decoder 8 and outputs the stored video data to the video output controller 10 according to an instruction from the video control instruction unit 12. Thus, the first video buffer 9a is provided preceding the video decoder 8 and the second video buffer 9b is provided following the video decoder 8, whereby a timing of the video signal Sv being processed can be advanced or delayed within a certain range. The first video buffer 9a and the second video buffer 9b are generically called video buffer 9.

Although in the present embodiment the video buffer 9 includes the first video buffer 9a and the second video buffer 9b, only one of the first video buffer 9a and the second video buffer 9b may be provided when a sufficient process time can be achieved. In order to reduce a capacity required for the video buffer 9, only the first video buffer 9a for storing video stream VS having not been decoded is preferably provided with the second video buffer 9b being eliminated.

The video output controller 10 subjects the video data having been decoded as described above, to various video processes such as enlargement, downsizing, fading-in, fading-out, shape change, color change, and morphing, thereby generating a video signal Sv. The video signal Sv is displayed as a dummy image on a display or the like.

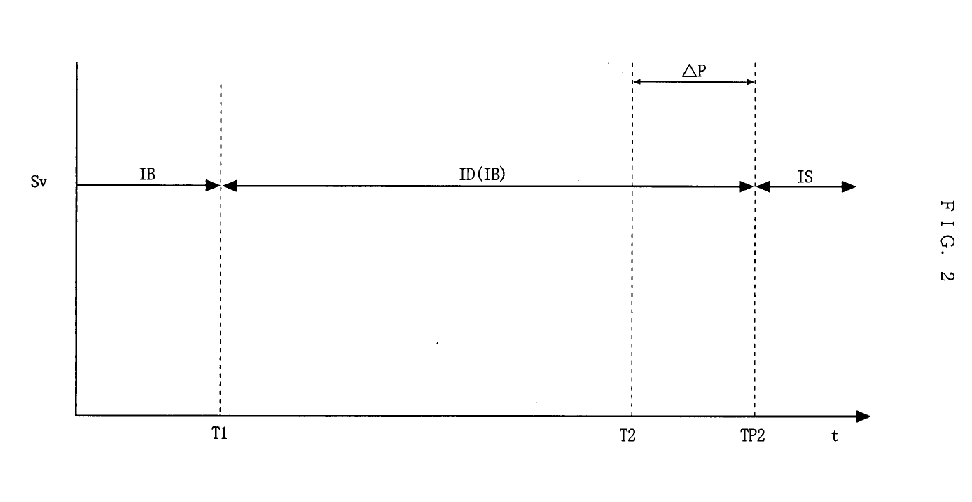

With reference to a timing chart shown in FIG. 2, displaying the dummy image according to the present invention will be described in detail. In FIG. 2, a reference symbol Sv in a vertical axis represents a video stream VS while a horizontal axis represents passage of time, that is, a time t. The time t increments from left to right. A thick line extending in parallel with the time axis represents a state of the video signal Sv outputted by the video output controller 10 at time t. Here, a user instructs a channel to be changed at time T1 and an initial I-picture of the video stream VS (contents data) is received at time T2 through a new channel selected by the user at time T1.

For making description easier, an image which has been received and displayed before a user instructs a channel to be changed is called “an unchanged image IB”, and the data thereof is called “unchanged image data”. That is, according to the present invention, the unchanged image IB is displayed before a user instructs a channel to be changed, and a dummy image ID is displayed immediately after the user instructs the channel to be changed, and a channel selection image IS is eventually displayed.

The time TP2 represents a designated reproduction time at which reproduced is the reproduced image unit UI including the initial I-picture received at time T2. The designated reproduction time will be briefly described. A stream included in the MPEG2-TS multiple stream MS carried on a broadcast wave Wb contains a time stamp for prescribing a time (display time) at which the reproduced image unit UI of contents included in the stream is to be reproduced and displayed. The time stamp is called the designated reproduction time TP in the present embodiment. The broadcast station transmits the MPEG2-TS multiple stream MS so as to be reproduced at the designated reproduction time TP based on the time stamp, the time stamp prescribing a predetermined prediction period ΔP before the designated reproduction time TP.

That is, the display time TP of the reproduced image unit UI including the initial I-picture received at time T is the time T plus the prediction time period ΔP (T+ΔP). Accordingly, the reproduced image unit UI including the initial I-picture received at time T2 is reproduced at a designated reproduction time TP2, that is, reproduced when the prediction time period ΔP elapses since the time T2. The prediction time period ΔP is typically about 0.5 to 1 second.

Initially, the unchanged image IB at time T1 will be described. The video stream VS at time T1 is in the following state. That is, at time T1, the reproduced image unit UI of the unchanged image IB is held in the video buffer 9. More specifically, the first video buffer 9a holds the video stream VS of the reproduced image unit UI having not been decoded and the second video buffer 9b holds video data of the reproduced image unit UI having been decoded. As the video buffer 9, at least one of the first video buffer 9a or the second video buffer 9b may be provided as described above.

The unchanged image IB which is the video stream VS of the reproduced image unit UI held in the video buffer 9 is used as the dummy image ID. That is, the video decoder 8 decodes the video stream VS of the unchanged image IB to generate unchanged image data. The video output controller 10 subjects the unchanged image data to a predetermined image process so as to generate a video signal Sv representing the dummy image ID. That is, the unchanged image IB itself or an image generated based on the unchanged image IB is used as the dummy image ID in a period from time T1 to the designated reproduction time TP2.

In FIG. 2, the reference symbol IB indicates that the unchanged image IB is displayed until time T1. The reference symbol ID(IB) indicates that the unchanged image IB itself having already been acquired at time T1 or the dummy image ID generated based on the unchanged image IB is displayed in a period from time T1 to the designated reproduction time TP2. The reference symbol IS indicates that the channel selection image IS is displayed at or after the designated reproduction time TP2.

When the prediction time period ΔP is shorter than the period from time T1 to the designated reproduction time TP2 (TP2-T1), it is impossible to display the unchanged image IB as the dummy image ID as it is so as to fill the period up to the designated reproduction time TP2, whereby a blank period occurs. In order to prevent this state, the video output controller 10 is used for subjecting the unchanged image IB to a process such as slow reproduction, repeated reproduction, or color change for each repetition of reproduction.

In the present embodiment, a portion of the unchanged image IB may be used as the dummy image ID of a still image instead of the unchanged image IB of a moving image being used as the dummy image ID. In this case, the unchanged image IB of the still image is subjected to image process immediately after time T1 at which a channel is instructed to be changed, whereby the unchanged image IB having been subjected to the image process can be displayed as the dummy image ID.

As described above, the dummy image ID generated based on the preceding unchanged image IB is dynamically changed and displayed without a blank period occurring during a change-over period from the instruction of channel changing up to the display of the channel selection image IS. Consequently, the unchanged image IB can smoothly shift to the channel selection image IS without irritating the user.

Returning to FIG. 1, the audio controller 17 generates an audio signal Sa based on an audio stream AS according to an instruction from the audio control instruction unit 18. Specifically, the audio controller 17 includes: an audio stream analyzer 13; an audio decoder 14; an audio buffer 15; and an audio output controller 16. The audio stream analyzer 13 analyzes an audio stream AS outputted by the demultiplexer 6. The audio buffer 15 temporarily stores the audio stream AS analyzed by the audio stream analyzer 13. The audio decoder 14 decodes the audio stream AS outputted by the audio buffer 15 to generate audio data. The audio output controller 16 subjects the decoded audio data to audio process such as fading-in or fading-out to output an audio signal Sa to a headphone, an internal speaker, or the like.

When the digital broadcast receiving apparatus 1 receives an instruction of channel changing from a user, the video buffer 9 and the audio buffer 15 are notified that an instruction of channel changing has been received, but continue to output, to the video decoder 8 and the audio decoder 14, the video stream VS and the audio stream AS which are held therein and relate to a service having been provided before the instruction of channel changing, respectively. As soon as the initial I-picture of a video and an audio which are related to a service to be provided after the channel changing are stored in the video buffer 9 and the audio buffer 15, respectively, the video controller 11 and the audio controller 17 cause the video buffer 9 and the audio buffer 15 to stop outputting, to the video decoder 8 and the audio decoder 14, the video stream VS (unchanged image IB) and the audio stream AS relating to the service having been provided before channel changing, respectively.

The aforementioned service represents display of contests which are received through the aforementioned digital broadcast or network and are provided as a digital stream. More specifically, the service represents display of programs which are broadcasted on different channels through digital broadcast using interframe interpolation.

The present invention has an advantage in that a video and an audio relating to a service having been provided before channel changing shift to a video and an audio relating to a service to be provided after the channel changing without a blank period occurring, and the change can be smoothly performed without irritating a user. The audio can be stopped as soon as instruction of channel changing is received. As described above, the service represents display of programs which are broadcasted on different channels through digital broadcast using interframe interpolation. In the present embodiment, a video and an audio relating to the service correspond to the video stream VS and the audio stream AS, respectively.

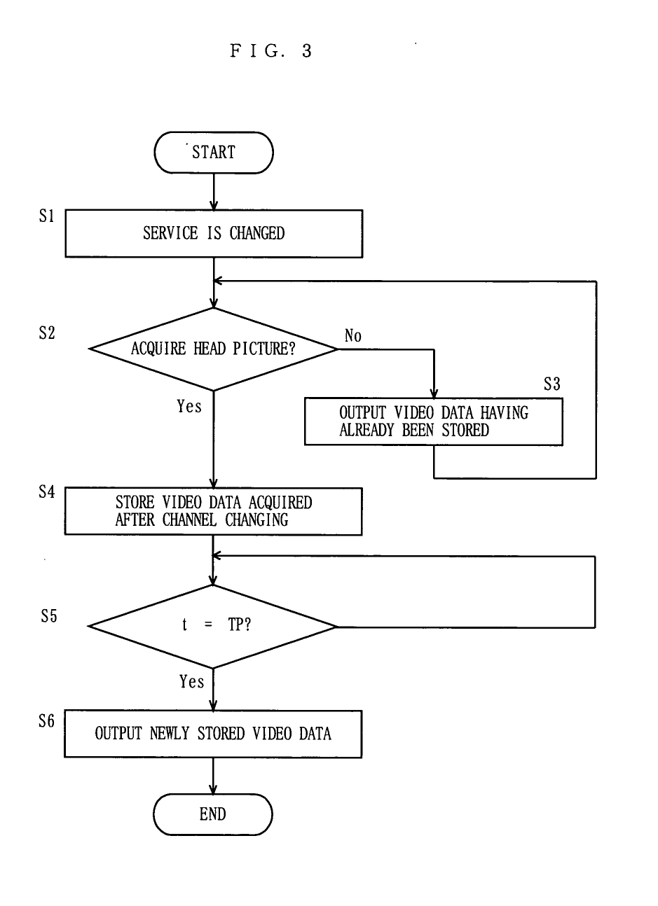

With reference to a flow chart shown in FIG. 3, an operation of the digital broadcast receiving apparatus 1 having the respective components thereof controlled by the video control instruction unit 12 so as to display the dummy image ID when a channel is changed, will be described. An operation of the dummy image ID being displayed (a process performed by the video control instruction unit 12 when a channel is changed) is started when receiving an instruction for selecting the channel from a user.

In step S1, the tuner controller 2 performs control so as to receive a service corresponding to the selected channel. At this time, the video buffer 9 holds the video stream VS (unchanged image IB) having been stored before channel changing. The process is advanced to the next step S2.

In step S2, it is determined whether or not the initial I-picture of a video (channel selection image IS) corresponding to a service to be provided after channel changing is acquired. In a case where the initial I-picture of the video (channel selection image IS) relating to the service to be provided after channel changing is not acquired (that is, determined as “No”), the process is advanced to the next step S3.

In step S3, the video stream VS (unchanged image IB) which has already been stored in the video buffer 9 before channel changing, is supplied to the video decoder 8. The video decoder 8 decodes video data from the video stream VS (unchanged image IB) having already been stored before channel changing, and the video output controller 10 subjects the decoded video data to image process to generate a video signal Sv. That is, the video signal Sv is displayed as the dummy image ID generated based on the unchanged image IB when the channel is changed. The process is returned to step S2.

As necessary, the video stream VS received before channel changing is referred to as a preceding channel video stream VS (P) and the video stream VS received after channel changing is referred to as a current channel video steam VS(C) so as to discriminate therebetween. Similarly, the video signal Sv generated before channel changing is referred to as a preceding channel video signal Sv(P), and the video data Sv generated after channel changing is referred to as a current channel video data Sv(C). That is, the preceding channel video stream VS (P) corresponds to the unchanged image IB while the current channel video stream VS(C) corresponds to the channel selection image IS. While the current channel video data Sv(C) principally corresponds to the aforementioned dummy image ID, the original image depends on the state at the aforementioned time T1.

When it is determined that an initial I-picture of a current channel video stream VS(C) is acquired in step S2 (Yes), the process is advanced to the next step S4.

In step S4, the current channel video stream VS(C) is stored in the video buffer 9. The process is advanced to the next step S5.

In step S5, it is determined whether or not the time 5 reached the time TP which is designated by the time stamp. When it is determined as “Yes”, the process is advanced to the next step S6.

In step S6, when the output is enabled, the current channel video stream VS(C) stored in the video buffer 9 is outputted to the video decoder 8, in which the current channel video data Sv(C) is generated.

In the present embodiment, the first video buffer 9a stores the preceding channel video stream VS(P) and the current channel video stream VS(C), which have not been decoded yet, and the second video buffer 9b stores the preceding channel video signal Sv(P) and the current channel video data Sv(C), which have been decoded by the video decoder 8.

With reference to FIG. 3, a description is given of the video. Needless to say, the same can be said for an audio. In this case, the preceding channel audio stream AS(P), the current channel audio stream AS(C), the preceding channel audio signal Sa(P), and the current channel audio data Sa(C) correspond to the preceding channel video stream VS(P), the current channel video stream VS(C), the preceding channel video signal Sv(P), and the current channel video data Sv(C), respectively.

As described above, in the embodiment of the present invention, a blank period which occurs when a user selects a channel, can be eliminated by displaying, as the dummy image ID, contents (unchanged image IB) having been viewed before a channel is selected. Further, since the dummy image ID represents contents (unchanged image IB) having been viewed before a user selects a channel, the dummy image ID is more closely associated with an operation of the user selecting the channel, as compared to the dummy image used in a conventional art.

That is, when the user sees the displayed dummy image ID, the user can easily recognize that the dummy image ID is displayed according to the instruction for selecting a channel from the user. Further, since the dummy image ID varies according to a channel selected by the user, the user can recognize that the dummy image ID is displayed while preparing for displaying a desired image (channel selection image IS) after the channel is selected, thereby preventing the user from being concerned about whether the player made an operation error or the apparatus malfunctions.

Further, data (corresponding to the unchanged image IB) which has been viewed, that is, which has been received or acquired, before a channel is selected, is used as dummy image data (corresponding to the dummy image ID), and therefore a load on the digital broadcast receiving apparatus 1 is prevented from being increased so as to specifically provide dummy image data or acquire the dummy image data, unlike in the case of a conventional art. Moreover, it is not necessary to additionally provide the digital broadcast receiving apparatus 1 with a function of obtaining video data as dummy image data, thereby leading to reduction in cost.

A method in which the aforementioned digital broadcast receiving apparatus 1 outputs the preceding channel video stream VS(P) as dummy image data, particularly in step S3, will be specifically described in a first example, a second example and a third example as follows.

### FIRST EXAMPLE

Initially, with reference to FIGS. 4, 5, and 6, a method for outputting a preceding channel video stream VS(P) according to a first example of the present invention will be described. The video output controller 10 subjects, to image process, the preceding channel video stream VS(P) as the aforementioned unchanged image IB so as to output a video signal Sv as the dummy image ID. Hereinafter, the process performed on the unchanged image IB (preceding channel video stream VS (P)) by the video output controller 10 will be described.

In FIG. 4, the preceding channel video stream VS (P) which is held in the video buffer 9 when an operation of channel changing is received from a user is illustrated as respective pictures in order of time. That is, a picture Pa1, a picture Pa2, a picture Pa3, and a picture Pa4 are illustrated in this order in FIG. 4, and the picture Pa4 is most recently acquired. The pictures Pa1 to Pa4 are generically called a preceding channel picture Pa. Further, although the pictures Pa1 to Pa4 represent different images which change with passage of time, the same picture, for example, picture Pa1, may be used. The preceding channel picture Pa corresponds to the aforementioned unchanged image IB.

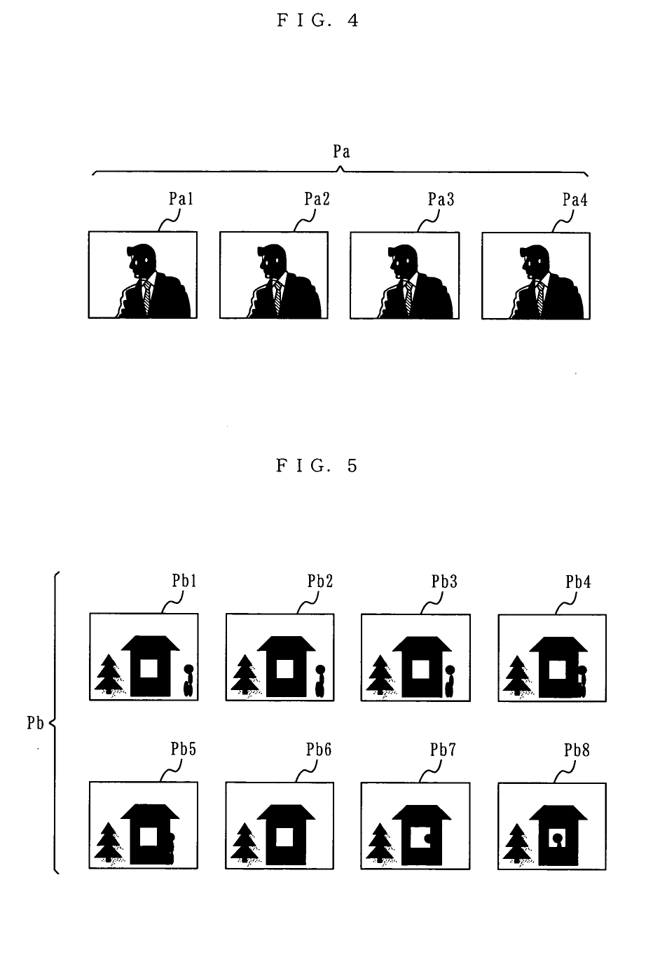

FIG. 5 illustrates, in order of time, an initial I-picture and pictures subsequent thereto, which are contained in the current channel video stream VS(C) having been acquired after a user changed a channel. In FIG. 5, a picture Pb1 which is the initial I-picture, a picture Pb2, a picture Pb3, a picture Pb4, a picture Pb5, a picture Pb6, a picture Pb7, and a picture Pb8 are illustrated in this order. The pictures Pb1 to Pb8 are generically called a current channel picture Pb. The current channel picture Pb corresponds to the aforementioned channel selection image IS.

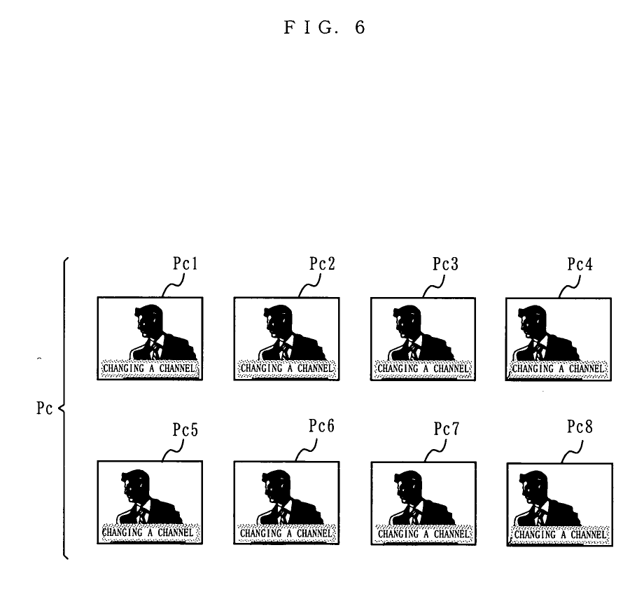

FIG. 6 shows an example of a dummy image ID according to the first example. In FIG. 6, the pictures Pc1 to Pc8 are obtained by putting a message of “changing a channel” or the like on the pictures Pa1 to Pa4 shown in FIG. 4 using OSD (On Screen Display) Pictures Pc1 to Pc8 are generically called a dummy picture Pc. That is, the dummy picture Pc is obtained by putting the message on the preceding channel picture Pa with the video output controller 10.

In the present example, eight dummy pictures Pc (Pc1 to Pc8) are provided. However, the blank period is a period from channel change to reception of an initial I-picture, and the blank period has a fixed maximum value depending on a type of the video stream VS. Accordingly, it is sufficient if the number of dummy pictures Pc to be provided corresponds to the number of pictures to be displayed in the maximum blank period for each video stream VS. In other words, when the number of dummy pictures Pc to be provided is smaller than the number of pictures to be displayed in the maximum blank period for the video stream VS, the same dummy picture Pc may be repeatedly displayed.

Specifically, the maximum blank period, that is, a maximum time period required for acquiring an initial I-picture, is five seconds to have one I-picture insert every five seconds. Accordingly, in the present invention, image process is performed such that the dummy pictures are displayed preferably for a maximum of five seconds (specifically, in a time period obtained by adding five seconds to a time period required for an operation of a channel being selected).

In the flow chart shown in FIG. 3, when the tuner controller 2 receives an operation of a channel being selected by a user, the tuner controller 2 performs control so as to receive a service corresponding to the selected channel in step S1. At this time, the video buffer 9 holds a preceding channel picture Pa which is a preceding channel video stream VS(P) having been stored before a channel is changed.

Next, until it is determined in step S2 that acquired is an initial I-picture of a current channel video stream VS(C) corresponding to a service to be provided after the channel is changed, the preceding channel picture Pa having already been stored in the video buffer 9 before the channel is changed is decoded and outputted in step S3.

That is, in the present example, the dummy picture Pc illustrated in FIG. 6 is displayed without displaying the preceding channel picture Pa as the dummy image ID. Thus, displayed is the dummy picture Pc obtained by adding a message indicating that the channel is being changed, to the preceding channel picture Pa having been viewed before the channel is instructed to be changed, thereby indicating to the user that the channel is being changed according to the instruction from the user, in the blank period up to acquisition of the I-picture of the current channel video stream VS(C).

The message to be added to the preceding channel picture Pa may have any content or the message may be added to the preceding channel picture Pa without using an OSD. Further, in a case where all the preceding channel pictures Pa held in the video buffer 9 are outputted before the initial I-picture (picture Pb1) is acquired, the final picture (picture Pa4) of the preceding channel picture Pa may be used to keep the dummy picture Pc or the like displayed until the initial I-picture (picture Pb1) is acquired.

As necessary, the initial I-picture (picture Pb1) and the pictures subsequent thereto (pictures Pb2 to Pb8) are acquired, and thereafter the initial I-picture and the pictures subsequent thereto are stored in the video buffer 9 in step 4, and the current channel picture Pb stored in the video buffer 9 are decoded and outputted when the output is enabled in step S6. During this period, the preceding channel audio stream AS(P) having already been stored in the audio buffer 15 before the channel is changed, may be outputted for the longest possible period or the preceding channel audio stream AS(P) may not be outputted.

As described above, in the present example, the effect of the aforementioned embodiment is obtained and further displayed is the dummy picture Pc (dummy image ID) obtained by the video output controller 10 adding a message indicating that a channel is being changed, to the preceding channel picture Pa (unchanged image IB) having been viewed before the channel is instructed to be changed, thereby indicating to the user that the channel is being changed according to an instruction from the user.

A second, a third, a fourth, and a fifth examples of the present invention are the same as the first example except that in the second to fifth examples the digital broadcast receiving apparatus 1 has different methods for outputting the preceding channel video stream VS(P), that is, performs different image processes using the video output controller 10. Hereinafter, only a method for outputting the preceding channel video stream VS (P) according to each example will be described.

### SECOND EXAMPLE

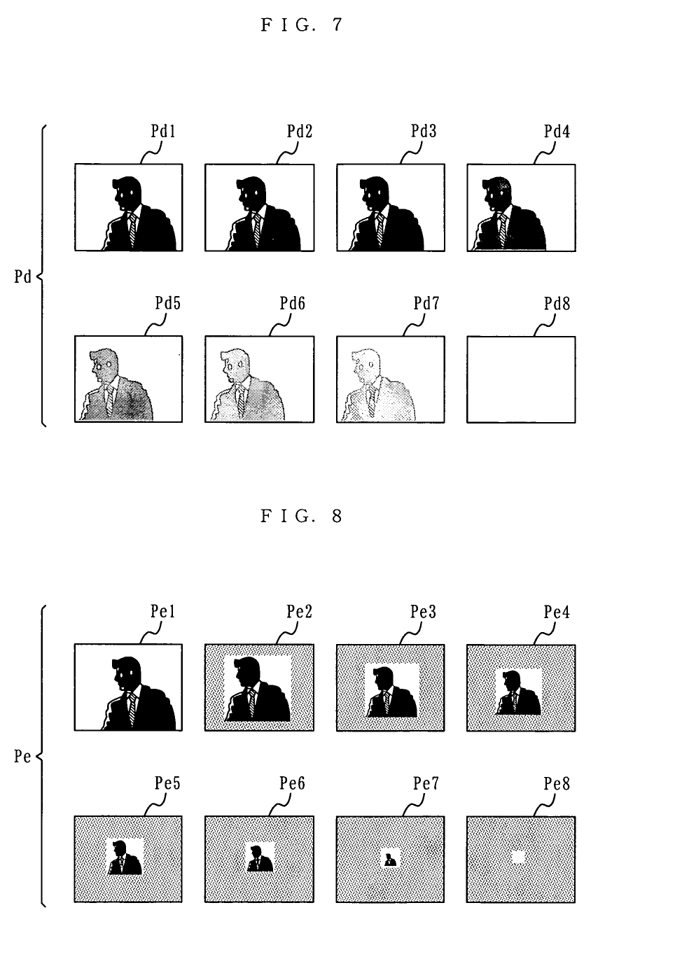

FIG. 7 shows an example of a dummy image ID according to a second example. In FIG. 7, pictures Pd1 to Pd8 are basically the same as the preceding channel picture Pa shown in FIG. 4. However, in the present example, the video output controller 10 processes images so as to gradually increase transparency of images toward picture Pd8 starting from the picture Pd1, and fades out the final picture Pd8. The pictures Pd1 to Pd8 are generically called a dummy picture Pd.

As described above, while the maximum blank period of the video stream VS is fixed, the number of dummy pictures Pd required varies depending on a time of a channel being selected (channel changing). Therefore, the dummy picture Pd is generated based on the unchanged image IB so as to display the dummy image ID until the next I-picture is inputted.

Thus, in the present example, the effects of the aforementioned embodiment and example are obtained and further the preceding channel picture Pa (unchanged image IB) having been viewed before an instruction of channel changing, is changed with passage of time, and the preceding channel picture Pa being changed with passage of time is displayed as a dummy image ID, thereby indicating to the user that channel change is being performed according to an instruction from the user and how much the channel change operation has progressed.

### THIRD EXAMPLE

FIG. 8 shows an example of a dummy image ID according to a third example. In FIG. 8, pictures Pe1 to Pe8 are basically the same as the preceding channel picture Pa shown in FIG. 4. However, in the present example, the video output controller 10 processes images so as to gradually reduce a screen size toward the picture Pe8 starting from the picture Pe1, and makes it difficult to view the picture Pe8. The pictures Pe1 to Pe8 are generically called a dummy picture Pe.

In the second and third examples, how “gradually”, i.e., a rate for increasing transparency or a rate for reducing the screen size can be arbitrarily set. In the present example, the effects of the aforementioned embodiment and examples are obtained and further it is indicated to a user that the channel change operation is being performed according to an instruction from the user and how much the channel change operation has progressed according to how small the dummy image ID is.

### FOURTH EXAMPLE

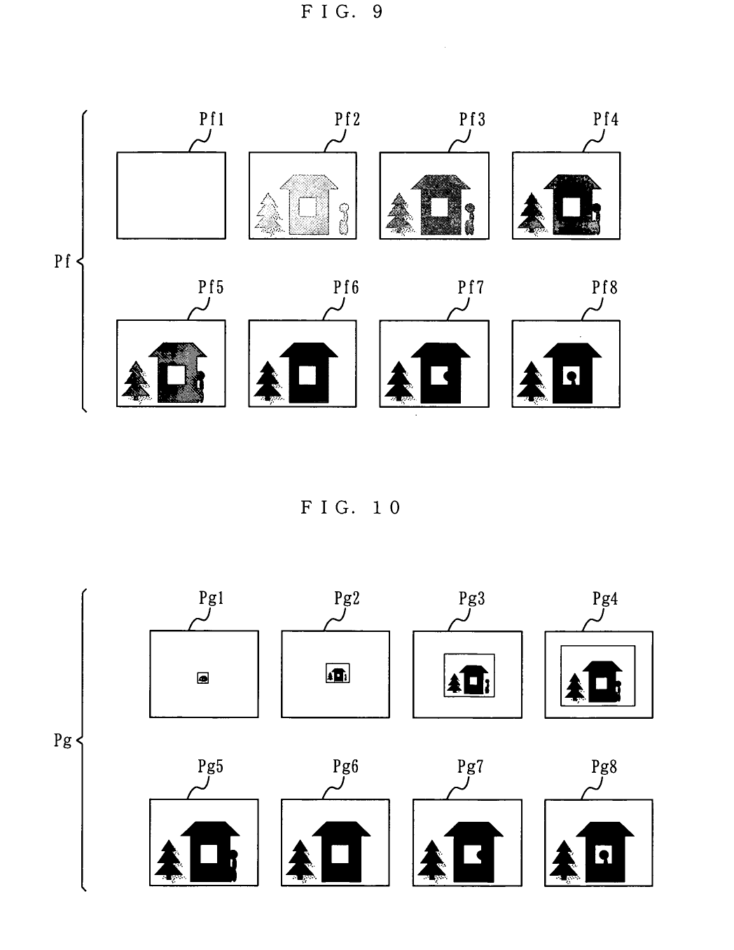

FIG. 9 shows an example of a dummy image ID according to a fourth example. In FIG. 9, pictures Pf1 to Pf8 are the same as the current channel picture Pb shown in FIG. 4. The video output controller 10 processes images so as to gradually reduce transparency of images toward the picture Pf8 starting from the picture Pf1, and fade in the picture Pf8. The pictures Pf1 to Pf8 are generically called a dummy picture Pf.

The number of dummy pictures Pf are appropriately determined based on the maximum blank period for each type of video stream VS, as described above.

In the present example, the effects of the aforementioned embodiment and examples are obtained and further it is indicated to a user that the channel change operation is being performed according to an instruction from the user and how much the channel change operation has progressed according to how clearly the dummy image ID is displayed (how much the dummy image ID is being faded in).

### FIFTH EXAMPLE

FIG. 10 shows an example of a dummy image ID according to a fifth example. In FIG. 10, pictures Pg1 to Pg8 are obtained by performing image process so as to gradually increase an image size of the current channel picture Pb shown in FIG. 5. Pictures Pg1 to Pg8 are generically called a dummy picture Pg.

In the fourth and fifth examples, how “gradually”, i.e., a rate for reducing transparency or a rate for increasing an image size can be arbitrarily set. For example, an image process may be performed in such a gradual manner as to increase the transparency up to 60% in increments of 10% and thereafter reduce the transparency from 60% in increments of 10% during channel changing. After the transparency reaches 60%, the channel selection image will soon be displayed. Therefore, the rate for reducing the transparency can be increased. For example, an image process may be performed so as to increase the transparency up to 60% in increments of 10%, and thereafter reduce the transparency from 60% in increments of 20%.

As described above, the present invention is applicable to a digital broadcast receiving apparatus for reproducing an image from an interframe interpolated digital stream and an AV mobile terminal having a camera function which enables image process to be performed on the same digital stream, and the like.

While the invention has been described in detail, the foregoing description is in all aspects illustrative and not restrictive. It is understood that numerous other modifications and variations can be devised without departing from the scope of the invention.

What is claimed is:

1. A digital broadcast receiving apparatus for receiving a digital stream obtained by subjecting a plurality of contents provided on a plurality of channels to interframe interpolation, selecting one of the plurality of contents and reproducing the selected contents, the digital broadcast receiving apparatus comprising:
a reproduction channel designating unit to operable to designate one of the plurality of channels and instructing for reproduction of contents provided on the designated channel;
a contents reproducing unit to operable to reproduce contents of the channel designated by the reproduction channel designating unit; and
a contents output unit to operable to output the reproduced contents, wherein
when, during reproduction of first contents provided on a first channel, an instruction for reproducing second contents provided on a second channel is received from the reproduction channel designating unit, the reproduced first contents are outputted until reproduction and output of the second contents are enabled.

2. The digital broadcast receiving apparatus according to claim 1, further comprising a contents output control unit to operable to control the contents output unit according to the reproduction instruction from the reproduction channel designating unit.

3. The digital broadcast receiving apparatus according to claim 1, wherein
the reproduction channel designating unit includes:
a tuner control unit to operable to cause a tuner to tune to the designated channel based on a channel selected by a user; and
a digital broadcast receiving unit to operable to receive the digital stream,
the contents reproduction unit includes:
a signal demodulating unit to operable to demodulate a digital signal from the received digital stream;
a demultiplexing unit to operable to demultiplex the digital signal into a video stream and an audio stream;
a video data decoding unit to operable to decode video data from the video stream;
a video stream analyzing unit to operable to analyze a picture of the video stream; and
a video data storage unit to operable to store the decoded video data, and
the contents output unit to operable to include a video output control unit to operable to cause the video data storage unit to operable to output the video data, and when the designated channel is changed from the first channel to the second channel, the video output control unit causes the video data storage unit to operable to output video data of a video stream which is provided on the first channel and are stored thereon until at least a head picture contained in a video stream provided on the second channel is received, and to output video data of the video stream provided on the second channel after the head picture is received.

4. The digital broadcast receiving apparatus according to claim 3, wherein
the video output control unit causes the video data storage unit to operable to output the video stream provided on the second channel at a designated reproduction time defined for the video stream.

5. The digital broadcast receiving apparatus according to claim 3, wherein
when the designated channel is changed from the first channel to the second channel and the video stream provided on the first channel in units of reproduced image is stored in the video data storage unit, the contents output unit outputs the video stream being stored.

6. The digital broadcast receiving apparatus according to claim 3, wherein
the video output control unit subjects a video which is provided on the first channel and stored in the video data storage unit to operable to image process, and outputs the video.

7. The digital broadcast receiving apparatus according to claim 3, wherein
the contents reproduction unit further includes:
an audio data decoding unit to operable to decode audio data from the audio stream; and
an audio data storage unit to operable to store the decoded audio data, and
the contents output unit further includes an audio output control unit to operable to cause the audio data storage unit to operable to output the audio data.

8. The digital broadcast receiving apparatus according to claim 7, wherein the audio output control unit subjects the audio data to signal process to output the audio data.

9. The digital broadcast receiving apparatus according to claim 6, wherein the image process includes generating a message screen indicating that an operation of channel selection by a user is received.

10. The digital broadcast receiving apparatus according to claim 6, wherein the image process includes a process for gradually changing an image.

11. The digital broadcast receiving apparatus according to claim 6, wherein the process for gradually changing an image includes gradually increasing transparency of an image.

12. The digital broadcast receiving apparatus according to claim 6, wherein the process for gradually changing an image includes gradually reducing transparency of an image.

13. The digital broadcast receiving apparatus according to claim 6, wherein the process for gradually changing an image includes gradually reducing a size of an image.

14. The digital broadcast receiving apparatus according to claim 6, wherein the process for gradually changing an image includes gradually increasing a size of an image.

15. A method for determining a video stream to be outputted using a digital broadcast receiving apparatus, the method comprising:
a service changing step for receiving an operation of channel selection from a user and changing service contents to be outputted;
a storage data output step for performing image process on a video stream obtained before the service contents stored in a video output buffer is changed, to output the video stream until a head picture contained in a newly selected video stream is received; and
a new data output step for outputting the newly selected video stream after the head picture is received.

16. A method for displaying received contents for use in a digital broadcast receiving apparatus for receiving a digital stream obtained by subjecting a plurality of contents provided on a plurality of channels to interframe interpolation, selecting one of the plurality of contents, and reproducing the selected contents, the method comprising:
a reproduction channel designating step for designating one of the plurality of channels and instructing for reproduction of contents provided on the designated channel;
a contents reproduction step for reproducing contents of channel designated by the reproduction channel designating unit;
a contents output step for outputting the reproduced contents; and
an output control step for outputting, when during reproduction of first contents provided on a first channel an instruction by the reproduction channel designating step for reproducing second contents provided on a second channel is received, the reproduced first contents until reproduction and output of the second contents are enabled.
